(19) United States
(12) Patent Application Publication
(10) Pub. No.: US 2020/0148261 A1
(43) Pub. Date: May 14, 2020

(54) LANE CHANGE AND COLLISION AVOIDANCE SYSTEM

(71) Applicant: Steering Solutions IP Holding Corporation, Saginaw, MI (US)

(72) Inventors: Tejas M. Varunjikar, Troy, MI (US); Jian Sheng, Madison Heights, MI (US)

(21) Appl. No.: 16/191,269

(22) Filed: Nov. 14, 2018

(51) Int. Cl. B62D 15/02; G06N 5/02; B62D 5/04

(52) U.S. Cl. CPC B62D 15/0265; B62D 5/0463; G06N 5/022

(57) ABSTRACT

A collision avoidance system for a vehicle includes at least one sensing device for detecting one or more obstacles proximate the vehicle. Also included is a model predictive control module for determining a predictive model path to avoid a collision with one or more objects during a lane change maneuver of the vehicle. Further included is a steering system receiving a steering angle command from the model predictive control module for automatically controlling the steering system to steer the vehicle along the predictive model path.

### BACKGROUND OF THE DISCLOSURE

The present invention relates to a steering aspect of a collision avoidance system.

Advances in occupant safety have played a significant role in reducing the number of fatalities and injuries in last few decades. These advances include passive safety measures (seat belt, airbag, chassis structure design, etc.), as well as active safety measures (ESC, ABS, adaptive cruise, etc.). The active safety technologies assist in avoiding a crash or mitigating the severity of a crash. Automatic braking systems aid in avoiding rear-end collisions.

Just like a braking system, the steering system (either electric power steering or steer-by-wire) can also contribute to active safety by helping a driver to avoid a collision or mitigate impact of a collision. It may be possible to avoid a rear-end collision if driver reacts early and effectively by applying brakes or steering or both.

Today's production vehicles already have lane assistance features, based on camera or radar, such as lane keep assist and lane centering. However, steering systems do not typically use camera information to automatically change a lane when desired by the driver or to avoid an accident. Automated vehicle lane change for obstacle avoidance has been researched for some time, however, most of the research work has focused only on vehicle level control in a lane change event. Also, such research is mainly focused on autonomous driving (no driver in the loop) scenarios.

### SUMMARY OF THE DISCLOSURE

According to one aspect of the disclosure, a method of collision avoidance is provided. The method includes assessing surrounding conditions of a vehicle with at least one sensing device. The method also includes determining an obstacle boundary of one or more obstacles proximate the vehicle. The method further includes computing a predictive model path to avoid a collision with the one or more obstacles during a lane change. The method yet further includes sending a command to control a vehicle steering system to follow the predictive model path.

According to another aspect of the disclosure, a collision avoidance system for a vehicle includes at least one sensing device for detecting one or more obstacles proximate the vehicle. Also included is a model predictive control module for determining a predictive model path to avoid a collision with one or more obstacles during a lane change maneuver of the vehicle. Further included is a steering system receiving a steering angle command from the model predictive control module for automatically controlling the steering system to steer the vehicle along the predictive model path.

According to yet another aspect of the disclosure, a two-dimensional collision avoidance system includes at least one sensing device for detecting one or more obstacles proximate a moving object. Also included is a model predictive control module for determining a predictive model path to avoid a collision with one or more obstacles during a maneuver of the moving object. Further included is a steering system receiving a steering angle command from the model predictive control module for controlling the steering system to steer the moving object along the predictive model path.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an aerial view of a vehicle having a collision avoidance system;

FIG. 2 schematically represents the collision avoidance system for the driver assisted vehicle;

FIG. 3 schematically represents operations of a model predictive control module for the collision avoidance system;

FIG. 4 is an aerial view of the vehicle according to another aspect of the disclosure;

FIG. 5 schematically represents the collision avoidance system for the driver assisted vehicle of FIG. 4;

FIG. 6 is an aerial view of the vehicle with a collision avoidance system according to another aspect of the disclosure; and

FIG. 7 is a schematic illustration of a steering system.

### DETAILED DESCRIPTION

Referring now to the Figures, where the invention will be described with reference to specific embodiments, without limiting same, a collision avoidance system is illustrated. As described herein, the collision avoidance system utilizes model predictive control to detect obstacles surrounding at least a portion of the vehicle and to determine a maneuver that avoids a collision with such obstacles. The maneuver may be a lane change or a braking event while the vehicle is in a manual driving mode, a semi-autonomous driving mode, or an autonomous driving mode.

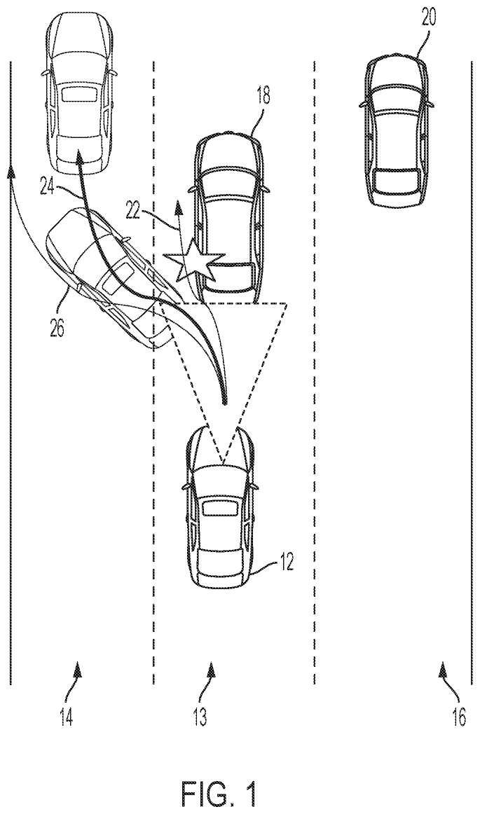

Referring to FIG. 1, illustrated is a vehicle 12 that includes the collision avoidance system described herein. As shown, the vehicle is positioned in a first lane 13, which in the illustrated embodiment is a center lane having two adjacent lanes, specifically a first adjacent lane 14 and a second adjacent lane 16. As can be appreciated, the vehicle 12 may be operated in any alternative lane configuration. For purposes of explanation, the illustrated lane configuration is described in detail by way of example only.

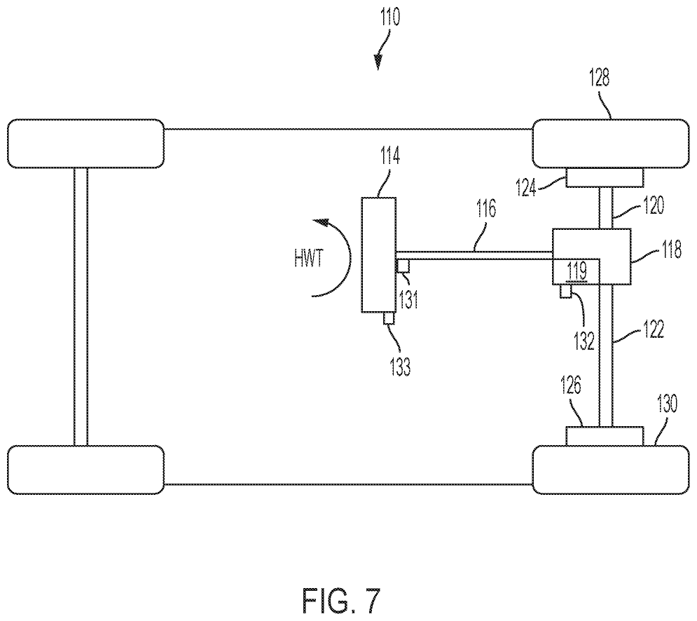

As shown in FIG. 7, the vehicle includes a steering system 100 that is schematically illustrated. As described herein, the steering system 100 can be an EPS, a steer-by-wire (SbW) system, a hydraulic steering with Magnetic Torque Overlay (MTO), and the like. In various embodiments, the steering system 100 includes a handwheel 114 coupled to a steering shaft system 116 which includes steering column, intermediate shaft, & the necessary joints. In one exemplary embodiment, the steering system 100 is an EPS system that further includes a steering assist unit 118 that couples to the steering shaft system 116 of the steering system 100, and to tie rods 120, 122 of the vehicle. Alternatively, steering assist unit 118 may be coupling the upper portion of the steering shaft system 116 with the lower portion of that system. The steering assist unit 118 includes, for example, a rack and pinion steering mechanism (not shown) that may be coupled through the steering shaft system 116 to a steering actuator motor 119 and gearing. During operation, as a vehicle operator turns the handwheel 114, the steering actuator motor 119 provides the assistance to move the tie rods 120, 122 that in turn moves steering knuckles 124, 126, respectively, coupled to roadway wheels 128, 130, respectively of the vehicle 12.

The vehicle further includes various sensors 131, 132, 133 that detect and measure observable conditions of the steering system 100 and/or of the vehicle. The sensors 131, 132, 133 generate sensor signals based on the observable conditions. In one example, the sensor 131 is a torque sensor that senses an input driver handwheel torque (HWT) applied to the handwheel 114 by the operator of the vehicle. The torque sensor generates a driver torque signal based thereon. In another example, the sensor 132 is a motor angle and speed sensor that senses a rotational angle as well as a rotational speed of the steering actuator motor 119. In yet another example, the sensor 133 is a handwheel position sensor that senses a position of the handwheel 114. The sensor 133 generates a handwheel position signal based thereon. Furthermore, signals like vehicle speed, yaw rate, heading angle are received from other sensors, and/or an ECU of the vehicle 110.

Referring again to FIG. 1, a first obstacle 18 in the form of vehicle is positioned ahead of vehicle 12 and within the first lane 13. In some other embodiments, the first obstacle can also be a pedestrian, an animal or other obstacle object. Due to braking of the first obstacle 18, it may be necessary for vehicle 12 to brake or make a lane change to avoid collision with the first obstacle 18. Additionally, collision avoidance is required during voluntary lane change maneuvers. For example, actuation of a turn signal may indicate to the collision avoidance system that a driver desires to make a lane change. Such an indication prompts the collision avoidance system to effectuate the lane change maneuver in a safe and efficient manner, as described herein. It should be noted that a turn signal can request the collision system to do a lane change just based on lane availability even when an obstacle is not detected in the surrounding. In either scenario, obstacle boundaries of one or more obstacles must be determined to ensure collision avoidance. A second obstacle 20 in the form of another vehicle is also positioned ahead of the vehicle 12, but in the second adjacent lane 16. This situation illustrates the complexity of determining how to best avoid collision of the vehicle 12 with one of the obstacles. It is to be understood that more or fewer obstacles may be present. The collision avoidance system that the vehicle 12 is equipped with is able to assess which maneuver, if any, is necessary to avoid collision with the obstacle 18.

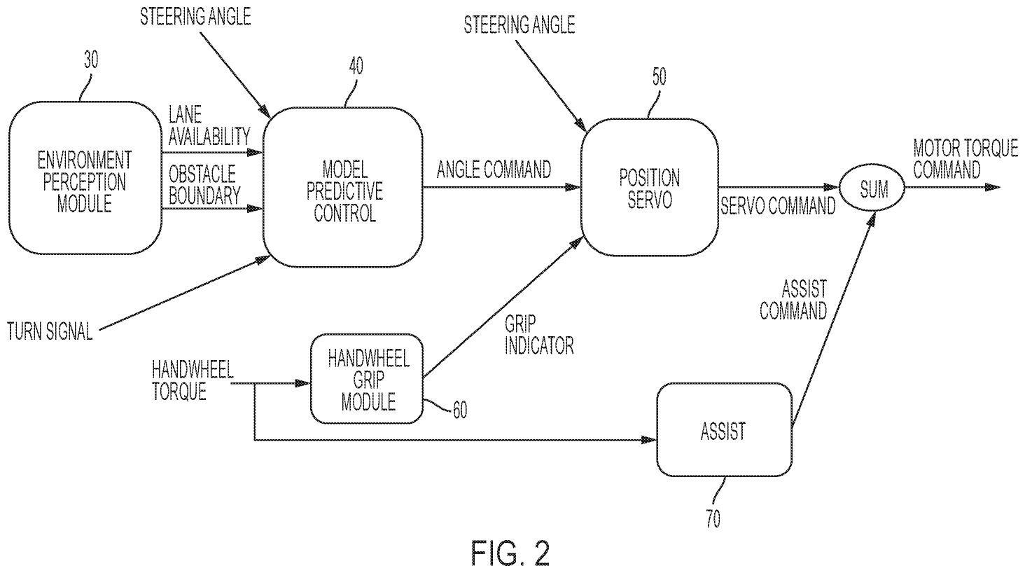

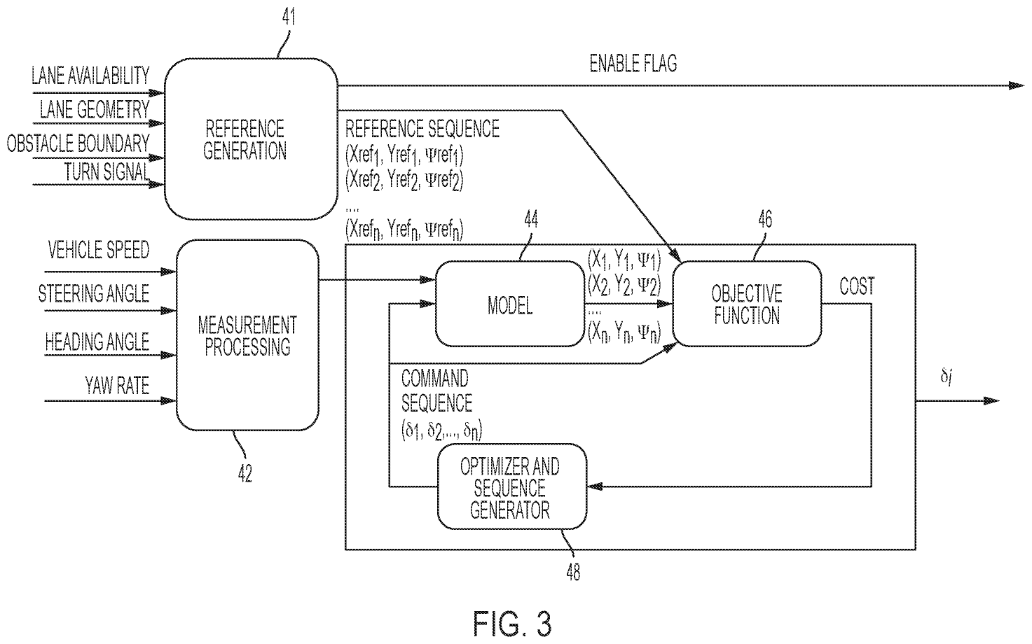

The illustrated example shows a situation where the driver is manually steering away from the first obstacle 18 along manual steering path 22. As noted above, and described in detail herein, the collision avoidance system assesses surrounding conditions of the vehicle 12 to determine steering maneuvers that avoid a collision, such as with the first obstacle 18. In this example, there is a detection of an impending collision with the first obstacle 18 along the manual steering path 22. The first adjacent lane 14 has been determined to be a feasible lane for a lane change along a predictive model path 24, while the second adjacent lane 16 is avoided due to the presence of the second obstacle 20 in the second adjacent lane 16. The predictive model path 24 is determined to be an optimal path for collision avoidance, as determined by the collision avoidance system. A driver assisted algorithm provides a torque overlay command through the process which is schematically illustrated in out FIGS. 2 and 3. The torque overlay command helps the driver steer into the left lane along the predictive model path 24 to avoid colliding with the first obstacle 18. Also shown is a path 26 that is determined to be too wide to safety position the vehicle 12 within the first adjacent lane 16.

Referring to FIG. 2, algorithm architecture for the collision avoidance system is shown. An environmental perception module 30 gathers information of lane availability and obstacle boundaries in at least a forward direction of a vehicle to determine the surrounding conditions of the vehicle 12. The environmental perception module 30 includes at least one of a camera, radar, LiDAR, and GPS. Alternative sensing devices are contemplated. One or more of the sensing devices provide data to be used as inputs into a model predictive control module 40. The model predictive control module 40 also receives inputs related to vehicle control, such as vehicle speed and steering angle, for example, such as from sensors 131-133, as well as other sensing devices. The model predictive control module 40 uses optimization algorithm(s) to determine a sequence of control actions (e.g., steering angle command) based on measured information, as well as reference command.

Referring to FIG. 3, processing operations within the model predictive control module 40 is illustrated. The model predictive control module 40 includes a reference generation unit 41, a measurement processing unit 42, a model unit 44, an objective function unit 46, and an optimizer and sequence generator unit 48. The reference generation unit 41 processes data of lane availability, lane geometry, obstacle boundary, and turn signal input to create a reference sequence and an enablement flag. The measurement processing unit 42 process data of vehicle speed, steering angle, heading angle, and yaw rate. The model unit 44 uses inputs from the measurement processing unit 42 in a vehicle dynamics model to predict the X-Y coordinate location (FIG. 1) and a yaw rate of the vehicle. This data is used to calculate a series of future predicted positions over time. In particular, the predicted location (X,Y) and orientation/heading (Ψ) of the vehicle 12 for the next n points is determined, i.e. over n*T_{mpc} time, as represented with the following equations:

Xₖ₊₁₌Xₖ₊Vₖ*cos(Ψₖ)*T_{mpc}

Yₖ₊₁₌Yₖ₊Vₖ*sin(Ψₖ)*T_{mpc}

Ψₖ₊₁₌Ψₖ+Vₖ*βₖ/lᵣ*T_{mpc}

In the formula tan(βₖ)=tan(δ_{rw,k})*lᵣ/(l_{f}+lᵣ),

l_{f} and Iᵣ represents a distance from the center of gravity of the vehicle 12 to the front and rear axis, respectively, where

δ_{rw,k} is the road-wheel angle of the vehicle 12 at k^{th} step;

Ψₖ is the heading angle of the vehicle 12 at k^{th} step;

Vₖ is the ground speed of the vehicle 12 at k^{th} step; and

βₖ is the sideslip angle of the vehicle 12 at k^{th} step.

The objective function unit 46 merges the reference sequence of the reference generation unit 41 and the next position over time data from the model unit 44 to predict a location and orientation of the vehicle 12 along with a command sequence from the optimizer and sequence generator unit 48 to generate a Cost Value. The Cost Value is calculated with the following equation:

$$Cost = {Cost}_{cte} + {Cost}_{epsi} + {Cost}_{beta} + {Cost}_{betaR} , where$$

$${Cost}_{cte} = {\sum }_{k = 1}^{n} {T}_{1} * ( {Y}_{k} - {Y}_{Targetk} )$$

$${Cost}_{epsi} = {\sum }_{k = 1}^{n} {T}_{2} * ( {ψ}_{k} - {ψ}_{Targetk} )$$

$${Cost}_{beta} = {\sum }_{k = 1}^{n} {T}_{3} * ( {β}_{k} )$$

$${Cost}_{betaR} = {\sum }_{k = 1}^{n} {T}_{4} * ( {β}_{k} - {β}_{k - 1} )$$

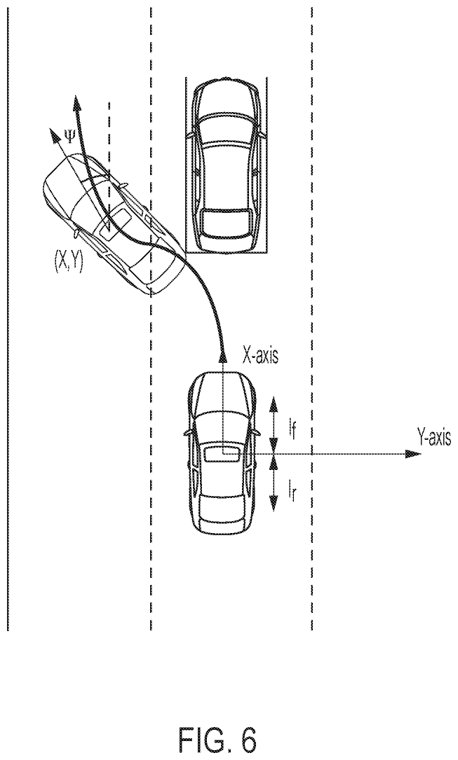

T₁, T₂, T₃, and T₄ are parameters which can be tuned according to different desired trajectories. Furthermore, constraints for vehicle motion path are calculated based on obstacle boundary received from Environment Perception Module, 30. The constraints help model predictive control to plan a vehicle path (X,Y) that does not come close to the obstacle position, as shown in FIG. 6. The optimizer and sequence generator unit 48 uses the Cost Value to iteratively compute a command sequence over multiple points to minimize the cost value. This cycle leads to the output of an angle command from the model predictive control module 40. It should be noted that the output angle command, δᵢ, could be a first calculated angle command, δ₁ from the command sequence, or a combination of all the values from command sequence, i.e., δᵢ=j₁*δ₁+j₂*δ₂+ . . . jₙ*δₙ, where all j's are less than or equal to 1, and greater than or equal to 0, and summation of all j's equates to 1.

Referring again to FIG. 2, the output steering angle command is sent from the model predictive control module 40 to a position servo module 50. The position servo module 50 uses the angle command of the model predictive control module 40 and a handwheel grip indicator value from a handwheel grip module 60 to generate a servo command for steering. The handwheel grip indicator value comes from the hand grip module 60 which uses a handwheel torque signal along with a threshold-based comparison to estimate a driver's grip on the handwheel of the vehicle, to calculate the handwheel grip indicator value. An assist module 70 calculates an assist command, this command being added to the servo command of the position servo 50 to generate a motor torque command of an electric power steering system.

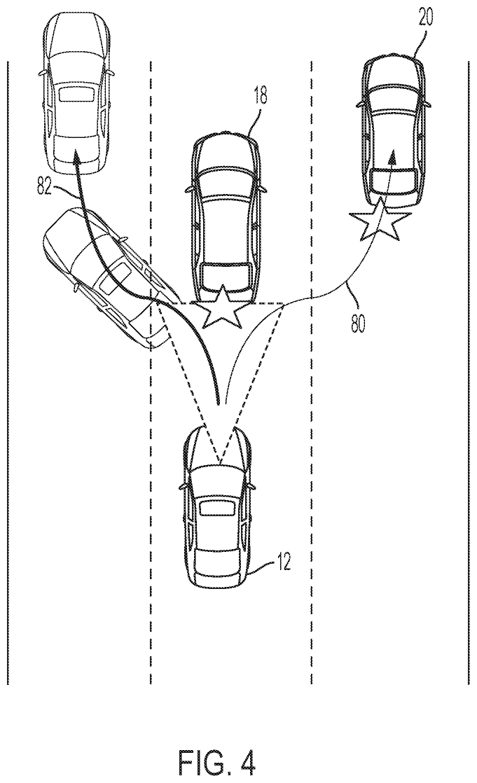

Referring to FIG. 4, the vehicle 12, first obstacle 18, and second obstacle 20 are shown once more to illustrate the vehicle being equipped with a steer-by-wire steering system, rather than an EPS system. In particular, the handwheel is not mechanically connected to the road wheels of the vehicle 12. The sensing devices described above detect an impending collision, as well as a feasible lane, as was the case with the EPS system. However, if the driver fails to respond or chooses an incorrect path 80 for lane change, the road wheel actuator system switches to active assist mode (which may also be characterized as automatically or partially automatically controlling) to follow a feasible path 82 for lane change, regardless of the driver input at the handwheel actuator. This may be achieved by transitioning the handwheel into a non-rotational condition in some embodiments.

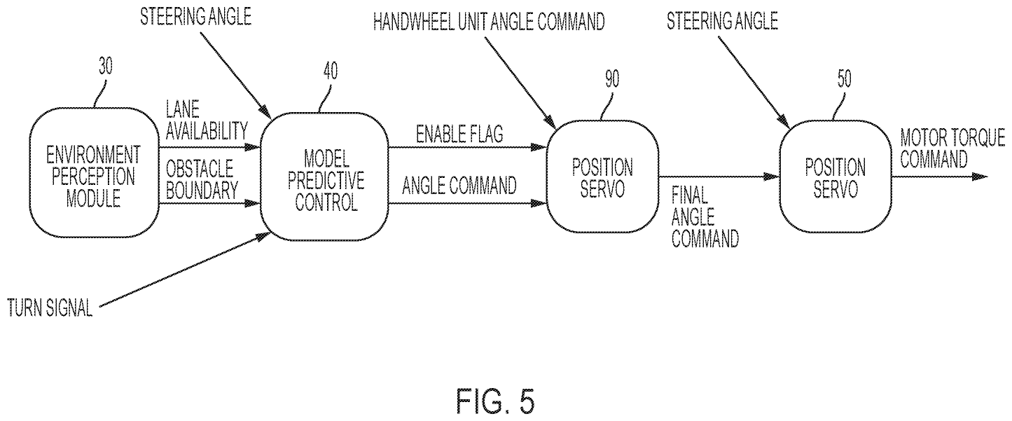

Referring now to FIG. 5, algorithm architecture for the collision avoidance system is shown for the steer-by-wire embodiment of FIG. 4. The environment perception module 30 and the model predictive control module 40 are the same as those described above in connection with FIGS. 2 and 3. However, the angle command goes to a command selection module 90 which sends an appropriate angle command as a final angle command to the position servo module 50. In normal operation, the road wheel actuator uses a handwheel unit angle as a command to perform position/angle control on the road wheel actuator unit. The handwheel unit sends a handwheel angle measurement/signal to the road wheel actuator in form of road wheel commands. The road wheel unit controls each road wheel to the commanded position or angle.

The embodiments described herein utilizes a model predictive control architecture to use sensing device information to automatically change a lane when desired by the driver or to avoid a collision. As described above, this may be done with vehicles operating in a manual driving mode, a semi-autonomous driving mode, or in a fully autonomous driving mode. Furthermore, vehicles equipped with EPS systems or steer-by-wire systems may benefit from the embodiments described herein.

As used herein, the terms module and sub-module refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules described herein can be combined and/or further partitioned.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A method of collision avoidance comprising:
assessing surrounding conditions of a vehicle with at least one sensing device;
determining an obstacle boundary of one or more obstacles proximate the vehicle;
computing a predictive model path to avoid a collision with the one or more obstacles during a lane change; and
sending a command to control a vehicle steering system to follow the predictive model path.

2. The method of claim 1, wherein the at least one sensing device comprises at least one of a camera, a radar device, a LiDAR device, and GPS.

3. The method of claim 1, wherein the predictive model path is calculated with a model predictive control module.

4. The method of claim 3, wherein the model predictive control module comprises a reference generation unit, a measurement processing unit, a model unit, an objective function unit, and an optimizer and sequence generator unit.

5. The method of claim 4, wherein the reference generation unit processes data of at least one of lane availability, lane geometry, obstacle boundary, and turn signal input to create a reference sequence and an enablement flag.

6. The method of claim 4, wherein the measurement processing unit process data of at least one of vehicle speed, steering angle, heading angle, and yaw rate.

7. The method of claim 4 wherein the model unit processes inputs from the measurement processing unit in a vehicle dynamics model to predict a X,Y location and a heading angle of the vehicle for a next position over time.

8. The method of claim 4, wherein the objective function unit merges the reference sequence of the reference generation unit and the next position over time data from the model unit to predict a location and orientation of the vehicle along with a command sequence from the optimizer and sequence generator unit to generate a cost value.

9. The method of claim 4, wherein the optimizer and sequence generator processes the cost value to iteratively compute the command sequence over multiple points to minimize the cost value.

10. The method of claim 1, wherein a model predictive control module determines an angle command to be sent to a position servo module.

11. The method of claim 10, wherein the position servo module processes the angle command of the model predictive control module and a handwheel grip indicator value to generate a servo command for steering.

12. The method of claim 10, wherein a handwheel grip module processes a handwheel torque signal with a threshold based comparison to estimate a drivers grip on a handwheel of the vehicle, to calculate the handwheel grip indicator value which is sent to the position servo module.

13. The method of claim 10, wherein an assist module calculates an assist command, the assist command being added to the servo command of the position servo module to generate a motor torque command of an electric power steering system.

14. A collision avoidance system for a vehicle comprising:
at least one sensing device for detecting one or more obstacles proximate the vehicle;
a model predictive control module for determining a predictive model path to avoid a collision with one or more obstacles during a lane change maneuver of the vehicle; and
a steering system receiving a steering angle command from the model predictive control module for automatically controlling the steering system to steer the vehicle along the predictive model path.

15. The collision avoidance system of claim 14, wherein the model predictive control module comprises a reference generation unit, a measurement processing unit, a model unit, an objective function unit, and an optimizer and sequence generator unit.

16. The collision avoidance system of claim 14, wherein the steering system is an electric power steering system.

17. The collision avoidance system of claim 14, wherein the steering system is a steer-by-wire steering system.

18. A two-dimensional collision avoidance system comprising:
at least one sensing device for detecting one or more obstacles proximate a moving object;
a model predictive control module for determining a predictive model path to avoid a collision with one or more obstacles during a maneuver of the moving object; and
a steering system receiving a steering angle command from the model predictive control module for controlling the steering system to steer the moving object along the predictive model path.
